(19) United States
(12) Patent Application Publication
(10) Pub. No.: US 2010/0079444 A1
(43) Pub. Date: Apr. 1, 2010

(54) DISPLAYPORT SLEEP BEHAVIOR

(75) Inventors: George C. Kyriazis, Cupertino, CA (US); Maciej Maciesowicz, Gilroy, CA (US); Colin Whitby-Strevens, Ben Lomond, CA (US)

Correspondence Address: TOWNSEND AND TOWNSEND AND CREW, LLP, TWO EMBARCADERO CENTER, 8TH FLOOR, SAN FRANCISCO, CA, 94111-3834, US

(73) Assignee: Apple Inc., Cupertino, CA (US)

(21) Appl. No.: 12/242,329

(22) Filed: Sep. 30, 2008

(51) Int. Cl. G06T 1/00

(52) U.S. Cl. 345/418

(57) ABSTRACT

Circuits, methods, and apparatus that allow a host to determine the capabilities of a new display that has replaced a previous display in a display system. In one example, a host determines capabilities of a new display after the host exits a sleep state. After exiting the sleep state, the host wakes an adapter. The adapter determines the presence of a display and sends a hot-plug detect interrupt signal to the host. Following this, the host reads information stored in the display and determines whether the adapter has been connected to a new display. If the adapter is connected to a new display, the host reads capabilities such as supported resolutions and refresh rates from the display and make adjustments to graphics output data as necessary.

### BACKGROUND

Computer display systems have advanced a tremendous amount since the days of the simple cathode-ray tube monitor. New flat panel displays have a myriad of capabilities and can support a wide range of resolutions and refresh rates. They are being driven by signals compliant with new standards, such as DisplayPort, and other new standards that are currently being developed or will be developed are sure to follow.

These computer display systems may include a host or source device and a display or sink device. Other systems may use a branch device functioning as a repeater when a display is located remotely from the host. Other systems may include a branch device operating as an adapter such that a host providing DisplayPort signals can drive a legacy display. An example is a display system where the host is a laptop computer, and the adapter is a dongle connected to a DisplayPort connector on the laptop and a cable connected to a legacy display. Still other systems may include a branch device to allow a host to provide graphics information to more than one display.

In some display systems, the display being used may on occasion be swapped or replaced. This is particularly common in display systems where the host computer is a laptop or notebook computer. In such a system, the laptop may be moved from an office, to a home, and to a conference room, connecting to a different display in each location.

One or more of these displays may have different capabilities. For example, they may support varying resolutions and refresh rates. Also, one or more of these displays may be compliant with a different video specification. In these circumstances, a user may need to change display settings each time the host is connected to a new display. This can be particularly frustrating where a user is unfamiliar with the capabilities of a particular display.

Thus, what is needed are circuits, methods, and apparatus that can automatically make adjustments when a new display is connected in a display system.

### SUMMARY

Accordingly, embodiments of the present invention provide circuits, methods, and apparatus that allow a host to determine the capabilities of a new display that has replaced a previous display in a display system.

In an exemplary embodiment of the present invention, the host determines the capabilities of a new display after the host exits a sleep state. This sleep state may be entered into following a period of user inactivity. When the host is a laptop computer, the host may enter a sleep state when a lid or top is closed on the laptop. While the host is in the sleep state, a display connected to the host may be replaced with a new display. For example, the host may be moved to a new location with a new display. The host may exit the sleep state by detecting user activity, or detecting that the laptop has been opened. Following this, the host reads information stored in the display and determines whether the host has been connected to a new display. If the host is connected to a new display, the host can read capabilities such as supported resolutions and refresh rates from the display and make adjustments as necessary.

In another exemplary embodiment of the present invention, a host is connected to a display via an adapter or branch device. The host may be a laptop or notebook computer, and the adapter may be a dongle that is connected to a DisplayPort connecter on the laptop via a DisplayPort cable. The dongle may connect to a DisplayPort or legacy display, such as a Video Graphics Array (VGA) or Digital Visual Interface (DVI) display via an appropriate cable. After exiting a sleep state, the host can wake the dongle by proving a signal on an auxiliary channel.

After waking, the dongle may detect the presence of a display. The dongle may then provide a hot-plug detect interrupt signal to the host. Upon receipt of this interrupt signal, the host then reads information regarding the display. This information may be stored on the display, for example in an extended display identification data (EDID) circuit or a DisplayPort control and data register. The host may then compare this information to information previously read and stored by the host. If the new information matches the stored information, then either the display has not been changed, or a new display is not sufficiently different from a previous display to require changes in graphics data output provided by the host. However, if the new information varies from the stored information, the host may make further inquires as to the capabilities of the display as needed. The host may then make adjustments to its output signals as needed.

In various embodiments of the present invention, the change in displays may be from a first DisplayPort display to a second DisplayPort display, from a DisplayPort display to a legacy display, from a legacy display to a DisplayPort display, or from a first legacy display to a second legacy display.

Various embodiments of the present invention may incorporate one or more of these and the other features described herein. A better understanding of the nature and advantages of the present invention may be gained by reference to the following detailed description and the accompanying drawings.

### BRIEF DESCRIPTION OF THE DRAWINGS

FIG. 1 illustrates a display system that is improved by the incorporation of an embodiment of the present invention;

FIG. 2 illustrates another display system that is improved by the incorporation of an embodiment of the present invention;

FIG. 3 illustrates circuitry that may be employed by a device in a display system according to an embodiment of the present invention;

FIGS. 4A-C illustrate the events occurring in a display system according to an embodiment of the present invention;

FIGS. 5A-C illustrate events occurring in a display system according to an embodiment of the present invention; and

FIG. 6 illustrates a flowchart of a method of determining whether a display has been changed during a sleep state, and then compensating for a change in display, according to an embodiment of the present invention.

### DESCRIPTION OF EXEMPLARY EMBODIMENTS

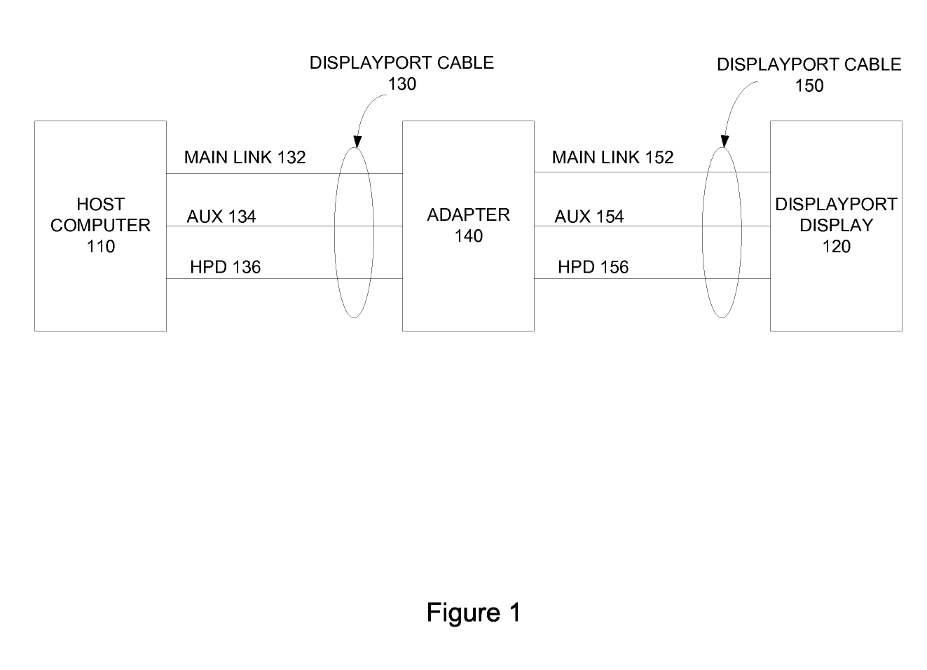

FIG. 1 illustrates a display system that is improved by the incorporation of an embodiment of the present invention. This figure includes a host computer (or source) 110 communicating with an adapter (or branch) 140 over a DisplayPort cable 130, the adapter 140 communicating with a display (or sink) 120 over a DisplayPort cable 150. While only one display 120 is shown, in other examples, the adapter 140 may drive more than one display 120. This figure, as with the other included figures, is shown for illustrative purposes and does not limit either the possible embodiments of the present invention or the claims.

The host computer 110 provides graphics information to the adapter 140 over the DisplayPort cable 130. The DisplayPort cable 130 includes lines for a main link 132, auxiliary channel 134, and hot-plug detect 136. The adapter 140 in turn provides graphics information to the DisplayPort display 120 over a DisplayPort cable 150. DisplayPort cable 150 includes lines for a main link 152, auxiliary channel 154, and hot plug detect 156.

Graphics information is provided by the host computer 110, typically using a graphics processor (not shown,) to a display 120 via the adapter 140, using main links 132 and 152. The main links 132 and 152 may utilize one or more lanes of data. Specifically, one, two, or four lanes of data may convey graphics information from the host computer 110 to the display 120.

Auxiliary channels 134 and 154 are used to convey support information between the host computer 110 and the display 120. The hot-plug detect lines 136 and 156 are used to inform the host computer 110 when a display 120 is connected or disconnected.

In this example, a host computer 110 provides graphics data to the display 120. In other embodiments of the present invention, other devices, such as set-top boxes, satellite receivers, and other systems, may provide the graphics information to the display 120. Also, while this and the other systems are shown as including DisplayPort devices and cables, embodiments of the present invention may be used to improve other types of systems that are currently available, are currently being developed, or will be developed in the future.

In this and the other included examples, the host 110 may be a laptop or notebook computer. The adapter 140 may be a dongle connected to the host computer 110 through a cable 130. The host computer 110 may include a DisplayPort connector to accept the cable 130. The dongle or adapter 140 may receive its power from the host computer 110. The dongle may include on or more connectors to connect to one or more displays, as well as translating circuitry for converting DisplayPort signals to signals compliant with VGA, DVI, or other video standard or proprietary technologies. These one or more connectors may be DisplayPort, VGA, DVI, or other types of connectors to connect to a compatible display via an appropriate cable.

In some circumstances, it may be desirable for a display to be remote from a computer. This may be the case in public venues, elevators, and other circumstances. In such a situation, the adapter 140, also know as a branch device, may be used to transmit graphics data over a distance. In other circumstances, it may be desirable to use more than one display in a display system. This may be the case in a workstation environment. In such a situation, a branch device may be used to provide data to more than one display.

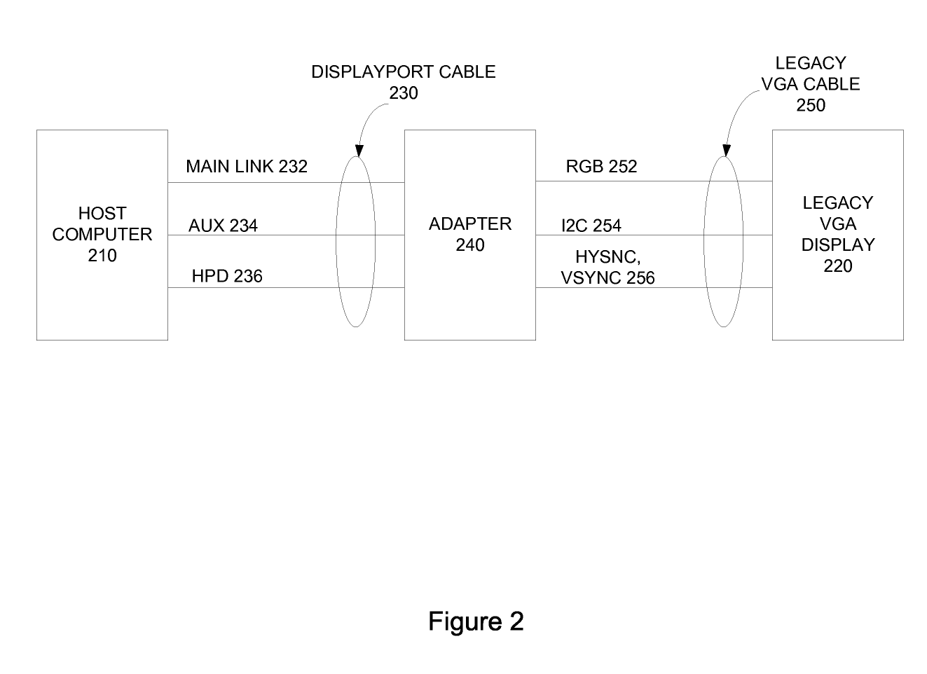

FIG. 2 illustrates a display system that is improved by the incorporation of an embodiment present invention. This figure includes a host computer 210 communicating with an adapter 240 over a DisplayPort cable 230. The adapter 240 in turn communicates with a legacy display 220 over a legacy cable 250. In this specific example, the legacy display 220 and legacy cable 250 are a VGA display and a VGA cable. In other embodiments of the present invention, the display 220 and cable 250 can be a DVI display and cable, or they may be compliant with other standard or proprietary signaling technology. In other examples, the adapter 240 may drive more than one display.

The host computer 210 communicates with the adapter 240 over a DisplayPort cable 230, which includes lines for a main link 232, auxiliary channel 234, and hot-plug detect 236. The adapter 240 communicates in turn with in the legacy VGA display 220 over VGA cable 250. VGA cable 250 includes RGB lines and their respective returns 252, I²C channel 254, and horizontal sync and vertical sync lines 256.

Legacy displays, such as the legacy VGA display 220, often include extended display identification data circuits. Extended display identification data circuits allow a host computer to determine a display's capabilities. For example, the supported resolutions, refresh rates, and other information is stored using extended display identification data circuits. This circuitry is accessed over the I²C lines 254. When the host 210 wants to learn about the legacy display 220, it can read information from this EDID circuitry.

This extended display identification data circuitry is a well-known commodity and has been used in displays for many years. For this reason, it is desirable to continue to make use of this circuitry even in newer displays, such as DisplayPort displays. However, existing circuitry does not convey many types of information that may be useful to a host when using these newer displays. Accordingly, embodiments of the present invention provide additional registers for storing this information. An example is shown in the following figure.

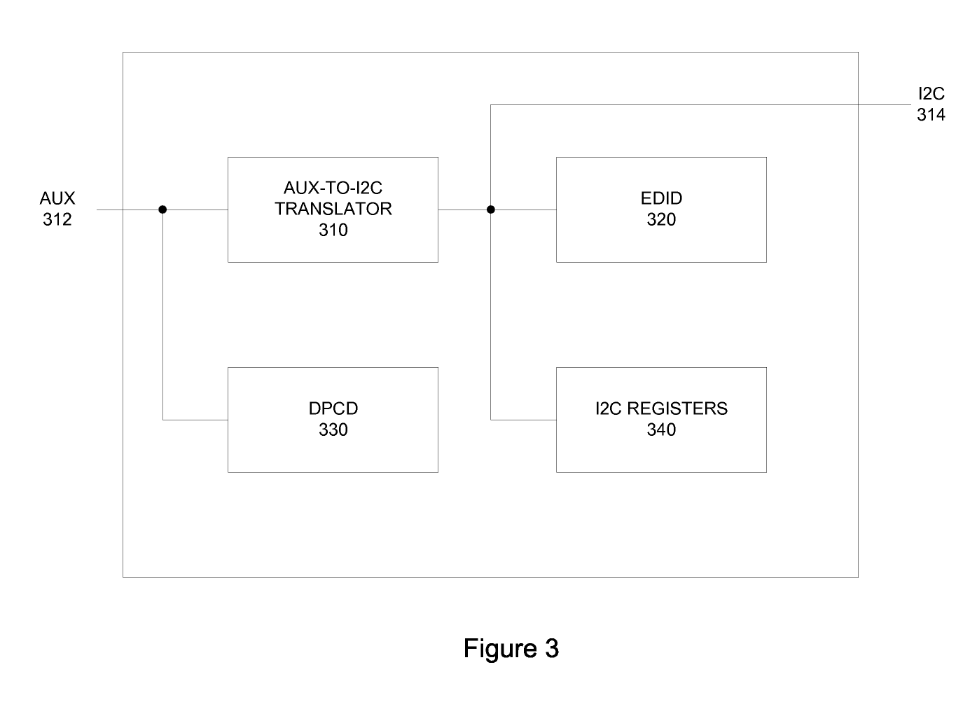

FIG. 3 illustrates circuitry that may be employed by an adapter or display according to an embodiment of the present invention. With a DisplayPort display, an auxiliary channel is used to communicate support information between a host and a display. However, as described above, currently available extended display identification data circuits send and receive data using the I²C protocol. Accordingly, the circuitry in FIG. 3 includes an auxiliary-to-I²C translator 310 to facilitate communication between the auxiliary channel and the EDID. The auxiliary-to-I²C translator 310 provides and receives auxiliary channel signals on lines 312 and provides and receives I²C signals on line 314. Specifically, the auxiliary channel signals on line 312 employ a tunneling protocol, that is, I²C signals are sent using auxiliary channel compatible signaling. The extended device identification data circuitry 320 provides information regarding supported resolutions, refresh rates, as well as other information. The extended device identification data circuitry 320 may also employ I²C registers 340. These registers may store information such as display settings including brightness, speaker volume, and other information.

Again, the extended display identification data circuitry 320 fails to include a great deal of information that may be useful in systems employing these newer displays. Accordingly, the circuitry in FIG. 3 includes DisplayPort control and data registers 330. These registers are specific to DisplayPort, therefore they are connected to the auxiliary data input 312 rather than the I²C bus 314. In other embodiments of the present invention, the DisplayPort control and data registers 330 are coupled to the I²C bus 314. These registers may include information regarding the manufacture and model, as well as information regarding software and firmware revisions. Information regarding the source or host devices, sink or display devices, and branches or adapters, may be included.

At various times, it is desirable for the host computer to enter a low-power state. At such a time, it may also be desirable for the host to place a display and any intervening adapters in a low-power state as well. This may be desirable, for example, during extended periods of user inactivity. In various embodiments of the present invention, different low-power states may be entered. For example, in a first low-power state, the host may provide screensaver information over the main link to a display. After doing this for a certain amount of time, the host may save further power by not providing this screen information and letting the display go dark. This second state may be referred to as a sleep state. In various embodiments where the host is a laptop computer, the sleep state may be entered when a cover or top of the laptop is closed. Where the adapter is a dongle attached to the laptop and where the dongle receives power from the laptop, it is often desirable that the dongle enter the sleep state along with the host in order to save power.

In a DisplayPort system, a host can put an adapter or display in a sleep state by writing a specific value to the register 600h in the DisplayPort control and data registers 330 and then stopping traffic on the main link. Specifically, the host writes a value of “2” to DisplayPort control and data register 600h and then stops traffic on the main link. The adapter can put a legacy display in the sleep mode by not providing graphics data to the legacy display. In a DisplayPort system, a host can wake an adapter or display from the sleep state by writing a value of “1” to DisplayPort control and data register 600h and then starting traffic on the main link. The adapter can wake a legacy display from the sleep mode by providing graphics data to the legacy display.

A problem may arise when the display system is in this sleep state. Specifically, a display may be replaced with a new display while the display system is in the sleep mode. This is particularly likely where the host is a laptop that is moved from one location to another, where each location has a different display. When this occurs, if the host computer continues to provide graphics data configured for the previous display, the new display may not be able to provide an image, or the provided image may not be optimal. For example, a first display having a first resolution and refresh rate may be replaced with a second display that either cannot operate at the first resolution and refresh rate, or cannot operate optimally at the first resolution and refresh rate. Alternately, a display capable of receiving four lanes of data on a main link may be replaced with a display capable of receiving only two lanes of data. When the display system comes out of sleep mode, if the host provides graphics data to the display using the previous refresh and resolution, or an incompatible number of lanes, the displayed image will not correctly (or optimally) appear.

Accordingly, in various embodiments of the present invention, the host computer determines the presence of a new display and makes appropriate adjustments. Specifically, after the presence of a new display is determined, the host computer learns what it needs to about the display, and changes the signals it provides accordingly. The change in displays may be from a first DisplayPort display to a second DisplayPort display, from a DisplayPort display to a legacy display, from a legacy display to a DisplayPort display, or from a first legacy display to a second legacy display. An example of the first two situations is shown on the following figures.

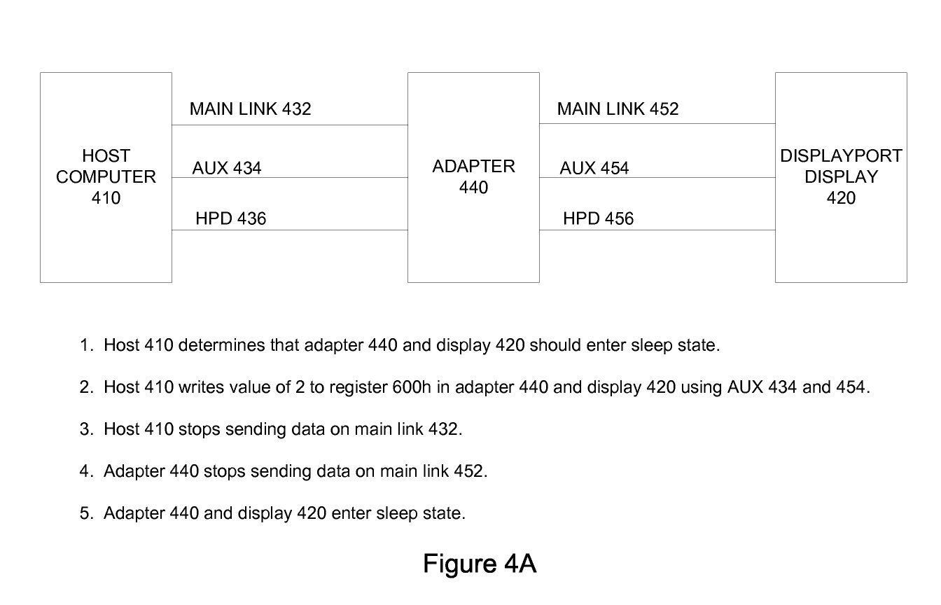

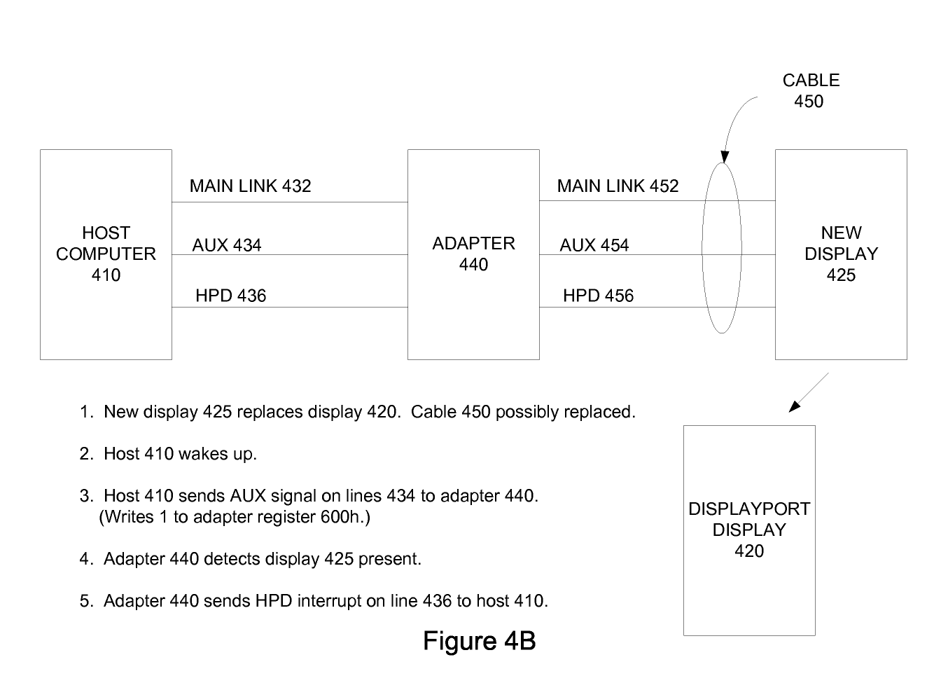

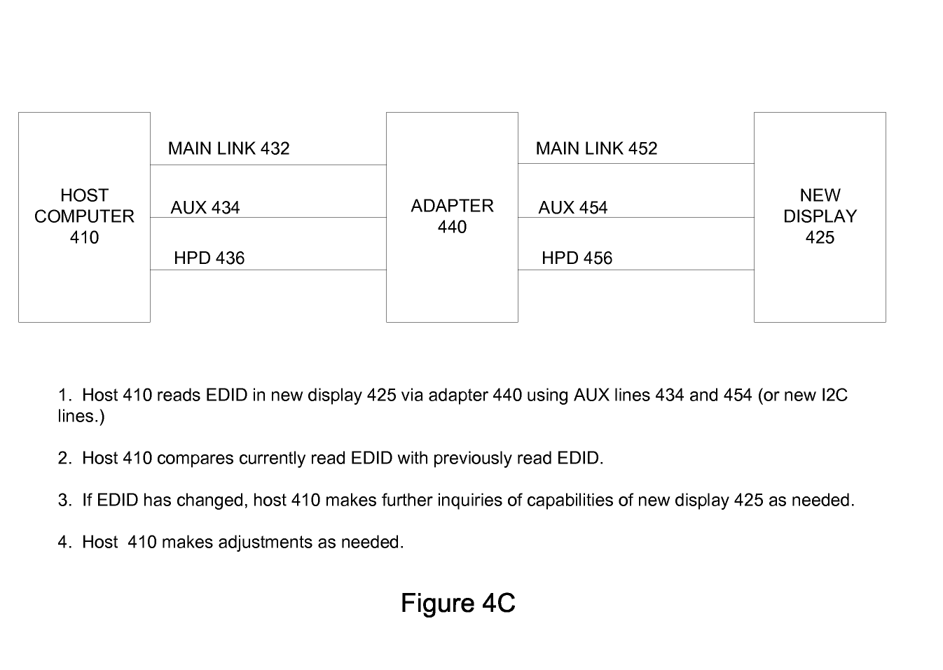

FIGS. 4A-C illustrate the events occurring in a display system according to an embodiment of the present invention. In FIG. 4A, a host computer 410 communicates with an adapter 440, which in turn communicates with a DisplayPort display 420.

The host 410 determines that the adapter 440 and display 420 should enter the sleep state. This may be due to the occurrence of an extended period of user inactivity, a cover closing when the host is a laptop computer, or for other reasons. Accordingly, host 410 writes a value of “2” to the DisplayPort control and data registers 600h in the adapter 440 and display 420 using the auxiliary channel lines 434 and 454. The host 410 then stops sending data on the main link 432. The adapter 440 in turn stops sending data on the main link 452 to the display. The adapter 440 and display 420 may then enter the sleep state.

In FIG. 4B, a new display 425 replaces the existing display 420. If the new display is a DisplayPort t display, the cable 450 may remain in place. If the new display 425 as a legacy display, the cable 450 may be replaced as well. A DisplayPort cable is shown here for simplicity. The host 410 then wakes up. This may be caused by a user moving a mouse, hitting a key on a keyboard, opening a cover when the host is a laptop, or for other reasons. Accordingly, the host 410 sends an auxiliary channel signal on lines 434 to adapter 440. In a specific example, the host computer 410 writes a “1” to DisplayPort control and data registers 600h in the adapter 440 and display 420 (if present.)

The adapter 440 detects the presence of a display, in this case display 425. Accordingly, the adapter 440 sends a hot-plug interrupt signal on line 436 to the host 410. This prompts the host to read the information regarding the display 425. This information may be read from extended display identification data circuitry or the DisplayPort control and data registers.

Specifically, in FIG. 4C, host 410 reads the extended display identification data in the new display 425 via the adapter 440 using the auxiliary channel lines 434 and 454. In various embodiments of the present invention, this information, or other information, may be read from the DisplayPort control and data registers. If the new display 425 is a legacy display, the adapter 440 reads the extended display identification data via the I²C lines. The host 410 then compares the currently read extended display identification data with previously read extended display identification data. If the extended display identification data has changed, the host 410 makes further inquiries of the capabilities of the new display 425 has needed. This information may be read from extended display identification data circuitry or the DisplayPort control and data registers. Following this, the host 410 can make adjustments to the signals provided to the remainder of the display system as needed. For example, the refresh rate, resolution, or number of lanes used may be changed.

Again, the display being swapped may alternately be a legacy display in that is traded in favor of a DisplayPort display, or a first legacy display swamped for a second legacy display. An example is shown in the following figure.

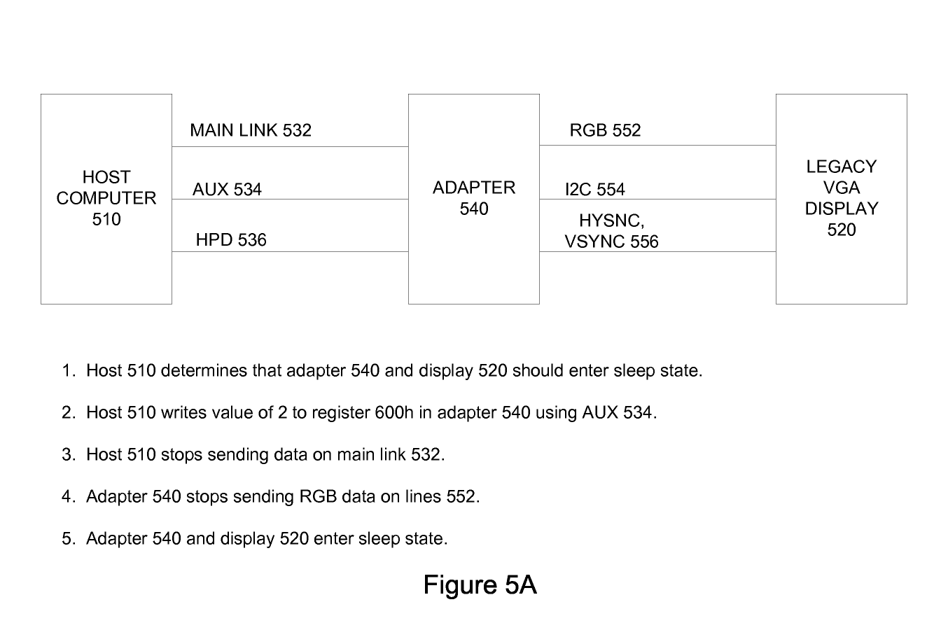

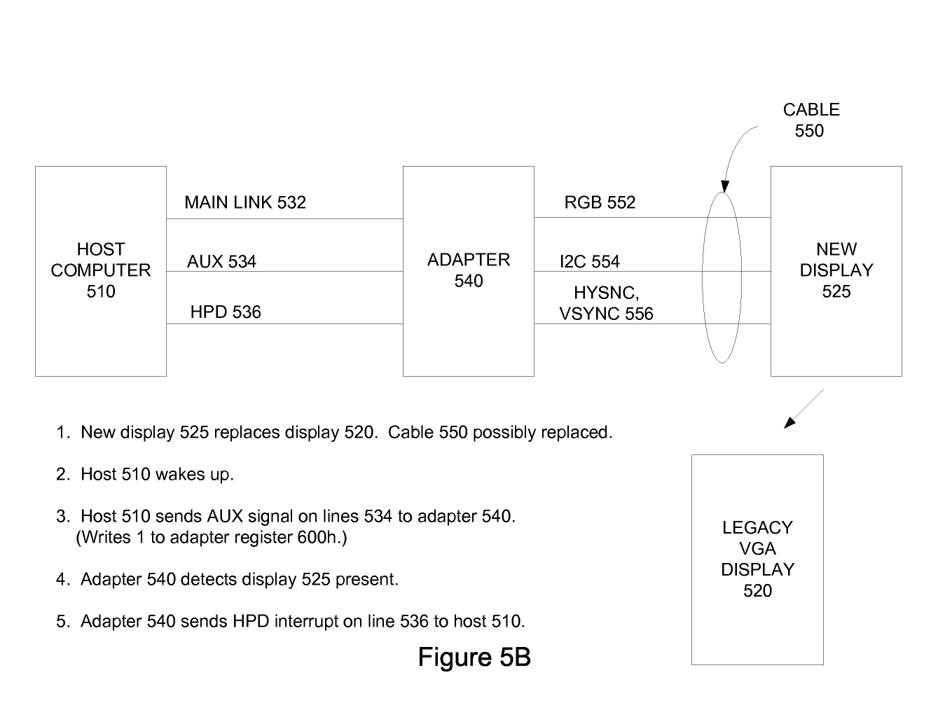

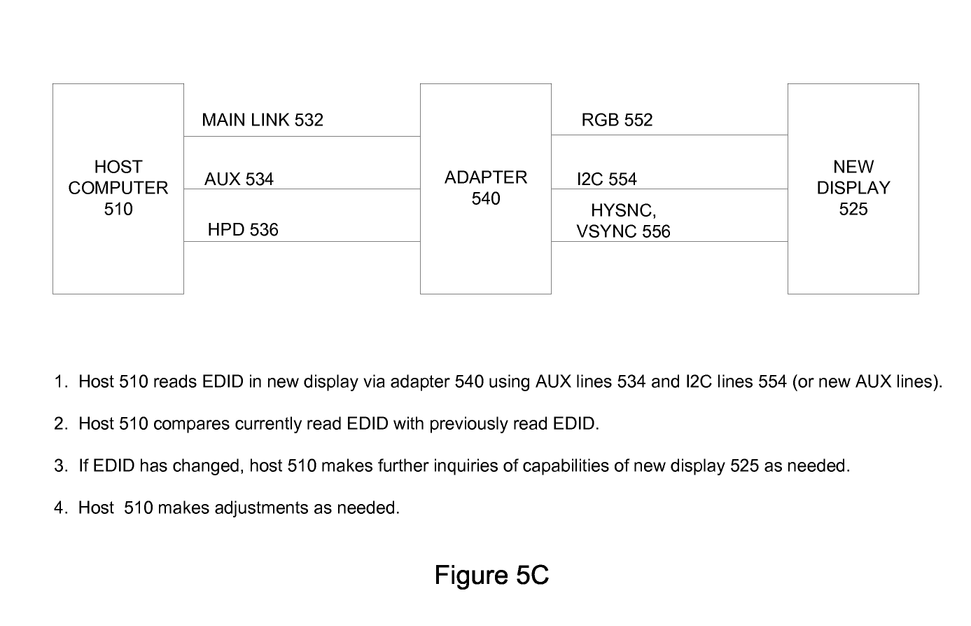

FIGS. 5A-C illustrate events occurring in a display system according to an embodiment of the present invention. In FIG. 5A, a host computer 510 communicates with an adapter 540, which communicates with a legacy display, shown here as a VGA display 520. In this example, the host determines that the adapter 540 and display 520 should enter the sleep state. This may again be due to the occurrence of an extended period of user inactivity, or, where the host is a laptop, a lid or cover may close. The host 510 writes a value of “2” to DisplayPort control and data register 600h in adapter 540 using auxiliary channel 534. The host 510 also stops sending data on the main link 532. The adapter 540 accordingly stops sending RGB data on lines 552. This causes the adapter 540 and display 520 to enter the sleep state.

In FIG. 5B, the display 520 is replaced by a new display 525. The cable 550 may also be replaced. The host 510 then wakes up. Again, this may be due to the detection of user activity such as the movement of a mouse or the pressing a key on a keyboard, or by the opening of a cover on a laptop. The host 510 then sends an auxiliary channel signal on lines 534 to adapter 540. For example, the host 510 may write a “1” to adapter DisplayPort control and data register 600h. The adapter 540 then detects the presence of the display 525. Accordingly, the adapter 540 sends a hot-plug interrupt on line 536 to host 510.

In FIG. 5C, the host 510 receives the hot-plug detect signal on line 536 and is prompted to read the extended display identification data on the new display via the adapter 540 using the auxiliary lines 534 and I²C lines 554. The host 510 then compares the currently read extended display identification data with previously read extended display identification data. If the extended display identification data has changed, host 510 makes further inquiries of the capabilities of the new display 525 as needed. This may be achieved by reading further information from the extended display identification data circuitry located on the new display 525. The host the 510 may then make adjustments as needed. For example, it may change the resolution or refresh rate of the graphics data it provides to the new display 525.

Accordingly, when exiting the sleep state, an adapter or branch device provides an interrupt to the host. This interrupt prompts the host to check extended display identification data on the display to see if a new display is present. If a new display is present, the host may determine whether changes are needed, and implement those changes. A flowchart illustrating this is shown in the following figure.

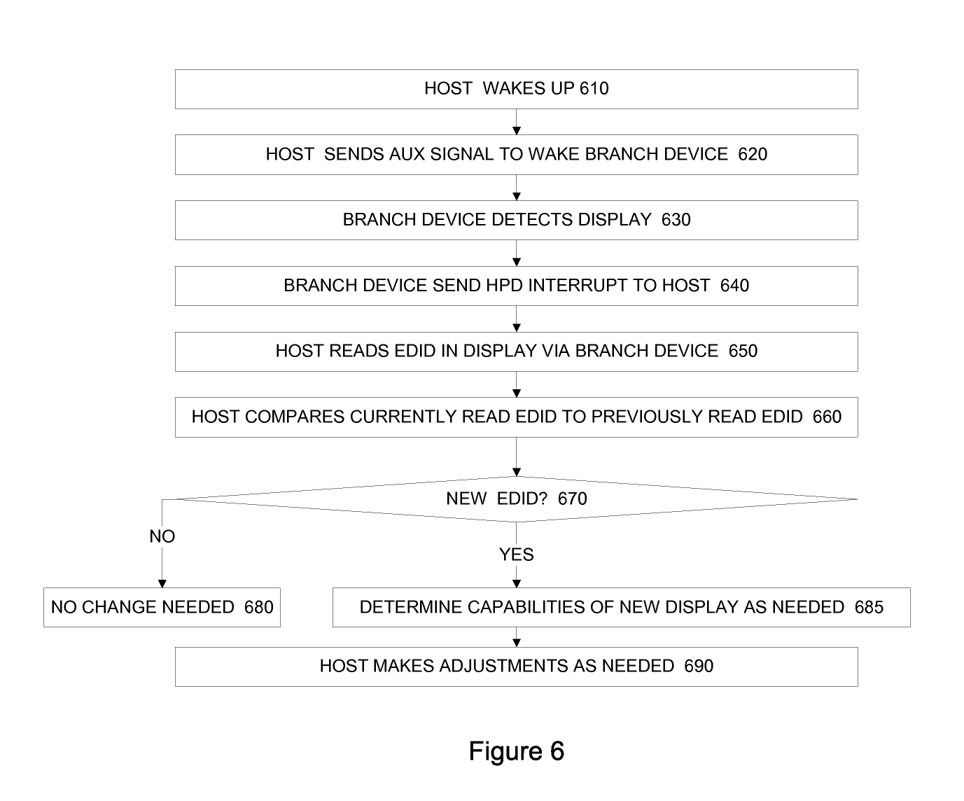

FIG. 6 illustrates a flowchart of a method of determining whether a display has been changed during a sleep state, and then compensating for a change in display, according to an embodiment of the present invention. In act 610, the host wakes up. In act 620, the host sends an auxiliary channel signal to wake the branch device. The branch device detects the presence of a display in act 630. Accordingly, the branch device sends a hot-plug detect interrupt to the host 640. The host then reads extended display identification data from the display the in the display device.

The host can then compare currently read extended display identification data to previously read extended display identification data in act 660. In act 670, the host determines whether the extended display identification data has changed. If it has not, no change is needed in act 680. If changes have been made, the host may determine capabilities of the new display as needed in act 685. In act 690, the host may make adjustments as needed to the signals it provides to the display.

The above description of exemplary embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

What is claimed is:

1. A method of providing graphics data comprising, with a host,
exiting a low-power state;
providing a signal on an auxiliary channel;
receiving a hot-plug detect interrupt signal;
reading information regarding a display;
comparing the read information regarding the display with stored information;
determining whether the read information regarding the display matches the stored information; and
if the read information regarding the display does not match the stored information, then
determining whether an adjustment is needed in a graphics data output; and if an adjustment is needed, then making the adjustment to the graphics data output and providing the graphics data output; otherwise
not adjusting the graphics data output and providing the graphics data output.

2. The method of claim 1 wherein the low-power state is a sleep state.

3. The method of claim 1 wherein the host is a laptop computer and the low-power state is exited when the laptop is opened.

4. The method of claim 1 wherein the information regarding the display is read from an extended display identification data circuit.

5. The method of claim 1 wherein the signal provided on the auxiliary channel comprises a signal instructing a register to write a value.

6. The method of claim 1 wherein the adjustment to the graphics data output comprises changing a refresh rate or a resolution.

7. A method of providing graphics data comprising, with a host computer,
exiting a sleep state;
providing a signal on an auxiliary channel to an adapter to write a value to a register on the adapter;
receiving a hot-plug detect interrupt signal from the adapter after the adapter determines the presence of a display;
reading information regarding the display from the display via the adapter;
comparing the read information regarding the display with stored information;
determining whether the read information regarding the display matches the stored information; and
if the read information regarding the display does not match the stored information; then
determining whether an adjustment is needed in a graphics data output; and if an adjustment is needed, then making the adjustment to the graphics data output and providing the graphics data output; otherwise
not adjusting the graphics data output and providing the graphics data output.

8. The method of claim 7 wherein the host computer is a laptop computer.

9. The method of claim 7 wherein the host computer communicates with the adapter over a DisplayPort cable.

10. The method of claim 7 wherein the host writes a value to a DisplayPort control data register on the adapter.

11. The method of claim 7 wherein the information regarding the display is read from an extended display identification data circuit.

12. The method of claim 7 wherein the adjustment to the graphics data output comprises changing a refresh rate or a resolution.

13. A computer system comprising:
a portable computer having a first connector;
a dongle having a first cable to connect to the first connector on the portable computer, a first register, and a second connector to connect to a first end of a second cable;
a display having a second register and a third connector to connect to a second end of the second cable,
wherein when the portable computer exits a sleep state, the portable computer writes a value to the register in the dongle, the dongle detects the display and sends a signal to the portable computer, the portable computer reads the contents of the second register in the display, compares the contents to stored content, and if the contents of the second register do not match the stored content, then the portable computer adjusts a graphics data output provided to the display.

14. The computer system of claim 13 wherein the dongle further comprises translation circuitry to translate DisplayPort signal to a legacy standard.

15. The computer system of claim 14 wherein the legacy standard is the Digital Visual Interface standard.

16. The computer system of claim 14 wherein the legacy standard is the Video Graphics Array standard.

17. The computer system of claim 13 wherein the signal the dongle sends to the portable computer is a hot-plug detect signal.

18. The computer system of claim 13 wherein the first connector is a DisplayPort connector.

19. The computer system of claim 13 wherein the first register is a DisplayPort control and data register.

20. The computer system of claim 19 wherein the second register is in an extended display identification data circuit.
